(19) United States
(12) Patent Application Publication
(10) Pub. No.: US 2026/0087511 A1
(43) Pub. Date: Mar. 26, 2026

(54) SYSTEM AND METHOD FOR GENERATING PERSONALIZED BRANDING CONTENT USING GENERATIVE ARTIFICIAL INTELLIGENCE

(71) Applicant: Assertion, Inc., Middletown, DE (US)

(72) Inventors: Srinivasan Narayanan, Maharashtra (IN); Satyam Lad, Maharashtra (IN); Sreekanth Subrahmanya Nemani, Maharashtra (IN); Sanjay P, Maharashtra (IN)

(21) Appl. No.: 19/339,017

(22) Filed: Sep. 24, 2025

(30) Foreign Application Priority Data
Sep. 24, 2024 (IN) 202411072169

(51) Int. Cl. G06Q 30/0201; G06Q 30/0204

(52) U.S. Cl. CPC G06Q 30/02013; G06Q 30/0204

(57) ABSTRACT

The present disclosure provides a system (106) and a method (300) for generating personalized branding content using Generative Artificial Intelligence (Gen AI). The system (106) receives campaign-specific data from entities, where the campaign-specific data includes default branding elements. The system (106) receives data and generates, via a Generative Artificial Intelligence (Gen AI) engine (214), customized messages to users based on the campaign-specific data and the data. The system (106) configures a pre-call consent message prior to establishing a call with the users and transmits a call purpose message and a branding content during the call, where the one or more customized messages include the call purpose message and the branding content. The system (106) in response to a determination that a response time associated with the Gen AI engine (214) exceeds a predetermined value generates pathways to transmit the default branding elements to the users.

### CROSS-REFERENCE TO RELATED APPLICATIONS

This application claims the benefit of foreign priority under 35 U.S.C. §119(a) to Indian Patent Application No. 202411072169, filed on Sep. 24, 2024, which is hereby incorporated by reference in its entirety.

### TECHNICAL FIELD

The present disclosure relates generally to the field of telecommunication. In particular, the present disclosure pertains to a system and method for generating personalized branding content using Generative Artificial Intelligence (Gen AI).

### BACKGROUND

In the current era, world is interconnected via telecommunication systems. The telecommunication systems play a pivotal role in business and personal communications. As businesses strive to differentiate themselves from each other and enhance customer engagement, the concept of call branding has emerged as a 15 crucial strategy. The call branding encompasses various techniques focusing at personalizing and enhancing the caller experience, thereby reinforcing brand identity and improving customer interaction.

Traditional telecommunication systems have primarily focused on basic functionalities such as call routing, voice transmission, and call management. However, these systems often lack mechanisms to customize or personalize the caller experience beyond basic caller identity (ID) information. As a result, there exists a need for solutions that integrate branding elements directly into the telecommunication process to create a more engaging and recognizable interaction for callers and recipients alike. The existing branding solutions push a static text, a Hypertext Transfer Protocol (HTTP) or a picture message (branding) to the customers as part of branding each call. This branding is configured per campaign and is the same for all customers that are part of the campaign. This may lack a personalised branding per customer. To make each customer to answer the call, the current solutions are not able to provide a personalised message to the customer. Also, the existing systems are not able to provide advanced level call branding.

Therefore, there is a well-established need to provide an improved system and method that overcomes the shortcomings associated with the existing solutions.

### OBJECTS OF THE PRESENT DISCLOSURE

An object of the present disclosure is to provide a system and method for generating personalized branding content using Generative Artificial Intelligence (Gen AI).

An object of the present disclosure is to provide a system that receives campaign-specific data from entities, where the campaign-specific data includes default branding elements.

An object of the present disclosure is to provide a system that receives data associated with users and generates, via a Generative Artificial Intelligence (Gen AI) engine, customized messages to the users based on the campaign-specific data and the data.

An object of the present disclosure is to provide a system that configures a pre-call consent message prior to establishing a call with the users and transmits a call purpose message and a branding content during the call, where the customized messages include the call purpose message and the branding content.

An object of the present disclosure is to provide a system that in response to a determination that a response time associated with the gen AI engine exceeds a predetermined value, generates pathways to transmit the one or more default branding elements to the one or more users.

### SUMMARY

In an aspect, the present disclosure relates to a system for generating personalized call branding. The system includes a processor and a memory operatively coupled with the processor, where said memory stores instructions which, when executed by the processor, cause the processor to receive campaign-specific data from one or more entities, where the campaign-specific data comprises one or more default branding elements. The processor receives data associated with one or more users. The processor generates, via a Generative Artificial Intelligence (Gen AI) engine, one or more customized messages to the one or more users based on the campaign-specific data and the data. The processor configures a pre-call consent message prior to establishing a call with the one or more users and transmits a call purpose message and a branding content during the call. The one or more customized messages include the call purpose message and the branding content. In response to a determination that a response time associated with the gen AI engine exceeds a predetermined value, the processor generates one or more pathways to transmit the one or more default branding elements to the one or more users.

In an embodiment, to generate the one or more pathways, the processor may be configured to determine if a rich call service (RCS) is being used and correspondingly transmit a hyperlink including the one or more customized messages dynamically generated by the GenAI engine or retrieved from a pre-generated database, where the one or more customized messages may include a branding image or a video. The processor may be configured to determine if an application-based branding is used and correspondingly allowing an application on a user equipment operated by at least one user among the one or more users to make a call to the Gen AI engine, where the Gen AI engine may dynamically generate the branding image or the video during the call. The processor in response to a determination that a request has been initiated by a server, may be configured to allow the server to invoke the Gen AI engine prior to initiating the call and embedding the branding image or the video in a message sent to the user equipment. The processor may be configured to use a telecommunications network to deliver the branding image or the video via call signaling prior to delivering the call to the user equipment.

In an embodiment, the Gen AI engine may be pre-configured with one or more brand constraints including any or a combination of a limiting media size or resolution associated with the branding image, a restricted inclusion of the one or more users, a restricted inclusion of one or more objects, or a restricted usage of one or more categories of content received from the one or more entities, a restricted usage of one or more authorized logos, a restricted usage of one or more themes, or one or more colours.

In an embodiment, the data may include at least one of an age attribute associated with the one or more users, a gender attribute associated with the one or more users, an education attribute associated with the one or more users, a location attribute associated with the one or more users, an economic status attribute associated with the one or more users, and one or more prior brand interaction attributes associated with the one or more users.

In an embodiment, the pre-call consent message may include a string of text sent to the one or more users prior to the call, where the call purpose message may include the string of text displayed during the call, and the branding image or the video may include an image or a video sequence displayed on the user equipment during the call.

In an aspect, the present disclosure relates to a system for generating personalized call branding. The method includes receiving, by a processor, associated with a system, campaign-specific data from one or more entities, where the campaign-specific data includes one or more default branding elements. The method includes receiving, by the processor, data associated with one or more users. The method includes generating, by the processor, via a Generative Artificial Intelligence (Gen AI) engine, one or more customized messages to the one or more users based on the campaign-specific data and the data. The method includes configuring, by the processor, a pre-call consent message prior to establishing a call with the one or more users and transmitting a call purpose message and a branding content during the call, where the one or more customized messages include the call purpose message and the branding content. The method includes in response to a determination that a response time associated with the gen AI engine exceeds a predetermined value, generating, by the processor, one or more pathways to transmit the one or more default branding elements to the one or more users.

In an embodiment, for generating the one or more pathways, the method may include determining, by the processor, if a rich call service (RCS) is being used and correspondingly transmitting a hyperlink including the one or more customized messages dynamically generated by the GenAI engine or retrieved from a pre-generated database, where the one or more customized messages may include a branding image or a video. The method may include determining, by the processor, if an application-based branding is used and correspondingly allowing an application on a user equipment operated by at least one user among the one or more users to make a call to the Gen AI engine, where the Gen AI engine may dynamically generate the branding image or the video during the call. The method may include in response to a determination that a request has been initiated by a server, allowing, by the processor, the server to invoke the Gen AI engine prior to initiating the call and embedding the branding image or the video in a message sent to the user equipment. The method may include using, by the processor, a telecommunications network for transmitting the branding image or the video via call signaling prior to delivering the call to the user equipment.

In an embodiment, the method may include pre-configuring, by the processor, the Gen AI engine with one or more brand constraints including any or a combination of a limiting media size or resolution associated with the branding image, a restricted inclusion of the one or more users, a restricted inclusion of one or more objects, or a restricted usage of one or more categories of content received from the one or more entities, a restricted usage of one or more authorized logos, a restricted usage of one or more themes, or one or more colours.

In an embodiment, the method may include receiving, by the processor, data associated with the one or more users prior to initiating the call. The method may include transmitting, by the processor, the data to the Gen AI engine for generating one or more customized messages comprising the one or more brand constraints.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 illustrates an example architecture 100 of a system 106 for generating personalized branding content using Generative Artificial Intelligence (Gen AI), in accordance with an embodiment of the present disclosure.

FIG. 2 illustrates an example block diagram 200 of the proposed system 106, in accordance with an embodiment of the present disclosure.

FIG. 3 illustrates an example flow diagram 300 of a method implemented by the proposed system 106, in accordance with an embodiment of the present disclosure.

FIG. 4 illustrates an example high-level flow diagram 400 implemented by the proposed system 106, in accordance with an embodiment of the present disclosure.

FIG. 5 illustrates an example computer diagram 500 implemented by the proposed system 106, in accordance with an embodiment of the present disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

The present disclosure provides a system for implementing personalised call branding. The system may use Customer Relationship Management (CRM) to obtain customer information such as but not limited to age, race, gender, location, education, economic status, past interactions with a brand, and the like for personalizing a branding message. For configuring a branded campaign, a set of information is provided. The set of information may include a pre-call consent message which may include a string of text that is sent to the customer prior to the call for obtaining the consent of the customer. Further, the set of information may include a call purpose with a string of text displayed while the call is ringing to provide context of the call to the customer. Furthermore, the set of information may include a branding image which may include a picture that is displayed on a device associated with the customer.

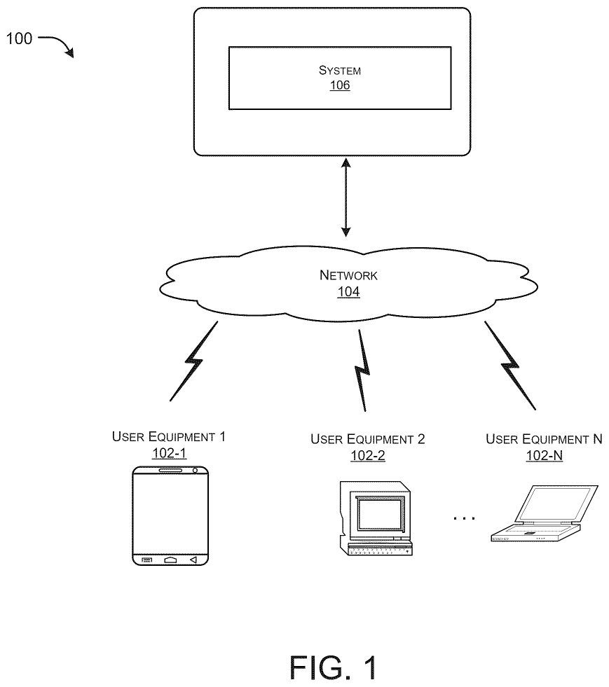

Various embodiments of the present disclosure will be explained in detail with reference to FIGS. 1-5.

FIG. 1 illustrates an example architecture 100 of a system 106 for generating personalized branding content using Generative Artificial Intelligence (Gen AI), in accordance with an embodiment of the present disclosure.

As illustrated in FIG. 1, in an embodiment, the system 106 may be communicatively coupled to one or more user equipments 102-1, 102-2 . . . 102-N via a network 104. A person skilled in the art may understand that the one or more user equipments 102-1, 102-2 . . . 102-N may also be referred as the user equipments 102 or the user equipment 102 throughout the disclosure.

In an embodiment, the network 104 may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network 104 may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system 106 may be configured to personalize a plurality of branding messages per customer or region or campaign. The system 106 may use Customer Relationship Management (CRM) or other means to obtain customer information or receive campaign-specific data from one or more entities, where the campaign-specific data may include one or more default branding elements. The one or more default branding elements may include but not limited to age, race, gender, location, education, economic status, past interactions with the brand, and the like for personalizing a branding message. The campaign-specific properties such as the purpose of the campaign, region, product, and other information may also be used to generate the branding. In an embodiment, for configuring a branded campaign, a set of information or data associated with a user/customer may be provided. The set of information may include but not limited to a pre-call consent message which may include a string of text that is sent to a customer prior to the call for obtaining the consent of the customer. A call purpose which may include a string of text may be displayed while the call is ringing to provide context of the call to the customer. A branding image which may include a picture that is displayed on a device associated with the customer. In an embodiment, the device 104 may be, but not limited to a mobile, laptop, or any other electronic device.

In an embodiment, the system 106 may configure a pre-call consent message prior to establishing a call with the customer and transmit a call purpose message and a branding content during the call, where the one or more customized messages may include the call purpose message and the branding content.

In an embodiment, the system 106 may include an administrator as part of configuring a campaign. In an embodiment, the administrator may be responsible to configure a predefined value for a pre-call consent message, a call purpose, and a branding image. The system 106 may retrieve customer information before dialling out each customer. The system 106 may then transfer the retrieved customer information to a Generative Artificial Intelligence (Gen AI) engine along with a default value for the pre-call consent message, a call purpose, and a branding image. In an embodiment, the branding provided by the system 106 may also include a text generated as part of the branding. The Gen AI engine may help in obtaining a personalised variant for the customer/user. The system 106 may then initiate the consent flow, and later the branded call flow for the customer using a plurality of personalised branding elements. In an embodiment, the Gen AI engine may typically refer to the next generation of artificial intelligence systems that are anticipated to be more advanced, versatile, and capable than current AI technologies.

In an embodiment, the system 106 may include a management portal for managing the outbound calling-based campaigns. In an aspect, the management portal may be able to create different Gen AI-based branding. Thus, the system 106 may use different Gen AI-based branding messages/images, and compare the performance of the campaigns with respect to each of the different Gen AI-based branding. Consider a non-limiting example where the Gen AI engine may use metrics such as connect rate and contact rate, to identify if a particular text or image is providing better results as compared to other different Gen AI-based branding. Further, for comparison, there may have some pre-defined boundary conditions, such that the Gen AI engine may only tinker within a predefined range. In a campaign, consider a non-limiting example of the predefined boundary, such as a pre-defined maximum discount of 30%, or a set of words or phrases may be blacklisted, a set of whitelisted words or phrases, and the like. In an embodiment, by comparing and selecting the efficiently performing images/text keywords, the Gen AI engine may incorporate a more effective branding image/text. Over time, this process enables the system 106 to synthesize more effective branding content than manual efforts.

In an embodiment, the system 106 may include an alternative mechanism. In an embodiment, in the alternative mechanism, if the Gen AI engine is down or takes too long time to reply, then the system 106 may continue with the consent and dialling flow using the predefined value. In response to a determination that a response time associated with the Gen AI engine exceeds a predetermined value, the system 106 may generate one or more pathways associated with the alternative mechanism to transmit the one or more default branding elements to the one or more users.

In an embodiment, the alternative mechanism may be implemented in a plurality of ways based on a mechanism through which branding occurs.

In an aspect, if rich call service or data is being used in the call, then a Hypertext Transfer Protocol (HTTP) link may be used to generate the branding at least one of an image or a video when the call is made or call lands on the device associated with the customer. The generated link may point to the Gen AI engine to generate the branding, or may point to a pre-generated branding image or video.

In an aspect, if application (app)-based branding is used, then the application on the device (104) or user equipment (104) associated with the customer may make a call to the Gen AI engine for generating at least one of the branding image or the video dynamically.

In an aspect, before the call is made, a server may invoke the Gen AI engine to generate at least one of the branding image or the video dynamically. The generated branding image or the video may be embedded in a message associated with an application installed on the device 104 or UE 104 associated with the customer. In an embodiment, the image may be readily available when the call arrives on the device 104 associated with the customer.

In an aspect, the system 106 may be called from a telecommunication network 104 before the system 106 delivers the call to the customer. The telecommunication network 104 may be embedded the branding in the call and transmit to the customer.

In an embodiment, to protect the brand and/or to enhance the branding using consistent themes, the Gen AI engine may be pre-restricted to generate certain kinds of images or videos. For example, the Gen AI engine may restrict the size of the image or video, the resolution, the people or objects used in the video, the logos and the colours. In an embodiment, the Gen AI engine may include full-screen images, and icon sized images. Some UEs 104 and operating systems may display branding in full-screen mode, while others only allow the display in icon-sized formats to provide compatibility across different devices and platforms, adapting the branding to the display capabilities of each system.

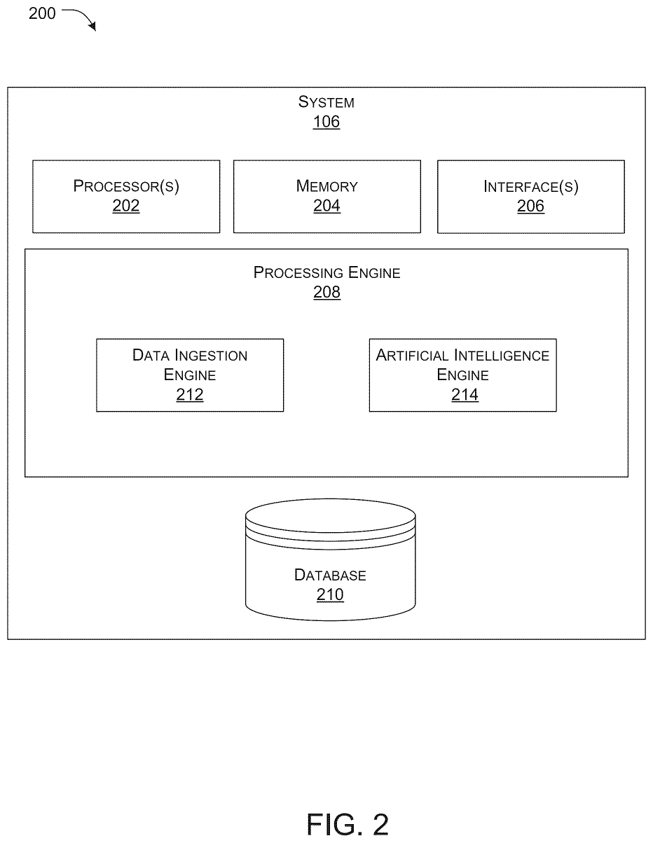

FIG. 2 illustrates an example block diagram 200 of the proposed system 106, in accordance with an embodiment of the present disclosure.

Referring to FIG. 2, the system 106 may comprise one or more processor(s) 202 that may be implemented as one or more microprocessors, microcomputers, microcontrollers, digital signal processors, central processing units, logic circuitries, and/or any devices that process data based on operational instructions. Among other capabilities, the one or more processor(s) 202 may be configured to fetch and execute computer-readable instructions stored in a memory 204 of the system 106. The memory 204 may be configured to store one or more computer-readable instructions or routines in a non-transitory computer readable storage medium, which may be fetched and executed to create or share data packets over a network service. The memory 204 may comprise any non-transitory storage device including, for example, volatile memory such as random-access memory (RAM), or non-volatile memory such as erasable programmable read only memory (EPROM), flash memory, and the like.

In an embodiment, the system 106 may include an interface(s) 206. The interface(s) 206 may comprise a variety of interfaces, for example, interfaces for data input and output (I/O) devices, storage devices, and the like. The interface(s) 206 may also provide a communication pathway for one or more components of the system 106. Examples of such components include, but are not limited to, processing engine(s) 208, a database 210, a data ingestion engine 212, and a Generative Artificial Intelligence (AI) engine 214.

In an embodiment, the processing engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor-executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the system 106 may comprise the machine-readable storage medium storing the instructions and the processing resource to execute the instructions, or the machine-readable storage medium may be separate but accessible to the system 106 and the processing resource. In other examples, the processing engine(s) 208 may be implemented by electronic circuitry.

In an embodiment, the processor 202 may receive campaign-specific data from one or more entities through the data ingestion engine 212. The one or more entities may include but not limited to one or more brand owners. The processor 202 may record the campaign-specific data in the database 210. The campaign-specific data may include one or more default branding elements.

In an embodiment, the processor 202 may receive data associated with one or more users. The one or more users may operate the UEs 104 for sending the data to the system 106. The data may include but not limited to an age attribute associated with the one or more users, a gender attribute associated with the one or more users, an education attribute associated with the one or more users, a location attribute associated with the one or more users, an economic status attribute associated with the one or more users, and one or more prior brand interaction attributes associated with the one or more users.

In an embodiment, the processor 202 may generate, via a Generative Artificial Intelligence (Gen AI) engine 214, one or more customized messages to the one or more users based on the campaign-specific data and the data. The Gen AI engine 214 may be pre-configured with one or more brand constraints including any or a combination of a limiting media size or resolution associated with the branding image, a restricted inclusion of the one or more users, a restricted inclusion of one or more objects, or a restricted usage of one or more categories of content received from the one or more entities, a restricted usage of one or more authorized logos, a restricted usage of one or more themes, or one or more colours.

In an embodiment, the processor 202 may configure a pre-call consent message prior to establishing a call with the one or more users and transmit a call purpose message and a branding content during the call, where the one or more customized messages may include the call purpose message and the branding content. In response to a determination that a response time associated with the Gen AI engine 214 exceeds a predetermined value, the processor 202 may generate one or more pathways to transmit the one or more default branding elements to the one or more users. The pre-call consent message may include a string of text sent to the one or more users prior to the call, the call purpose message may include the string of text displayed during the call, and the branding image or the video may include an image or a video sequence displayed on the user equipment during the call.

In an embodiment, to generate the one or more pathways, the processor 202 may be configured to determine if a rich call service (RCS) is being used and correspondingly transmit a hyperlink comprising the one or more customized messages dynamically generated by the GenAI engine 214 or retrieved from a pre-generated database, where the one or more customized messages may include a branding image or a video. The processor 202 may be configured to determine if an application-based branding is used and correspondingly allowing an application on the UE 104 operated by at least one user among the one or more users to make a call to the Gen AI engine 214, where the Gen AI engine 214 may dynamically generate the branding image or the video during the call. The processor 202 may be configured to in response to a determination that a request has been initiated by a server, may allow the server to invoke the Gen AI engine 214 prior to initiating the call and embedding the branding image or the video in a message sent to the UE 102. The processor may be configured to use a telecommunications network 104 to deliver the branding image or the video via call signaling prior to delivering the call to the UE 104.

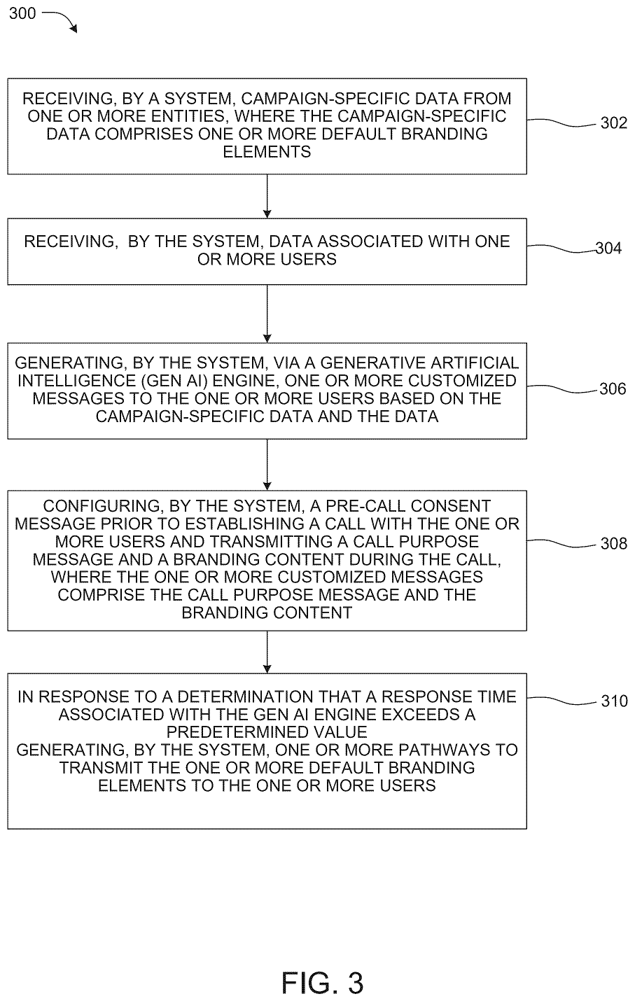

FIG. 3 illustrates an example flow diagram 300 of a method implemented by the proposed system 106, in accordance with an embodiment of the present disclosure.

As illustrated in FIG. 3, at step 302, the method may include receiving, by a system 106, campaign-specific data from one or more entities, where the campaign-specific data may include one or more default branding elements. At step 304, the method may include receiving, by a system 106, data associated with one or more users. At step 306, the method may include generating, by the system 106, via a Generative Artificial Intelligence (Gen AI) engine 214, one or more customized messages to the one or more users based on the campaign-specific data and the data. At step 308, the method may include configuring, by the system 106, a pre-call consent message prior to establishing a call with the one or more users and transmitting a call purpose message and a branding content during the call, where the one or more customized messages may include the call purpose message and the branding content. At step 310, the method may include in response to a determination that a response time associated with the Gen AI engine 214 exceeds a predetermined value, generating, by the system 106, one or more pathways to transmit the one or more default branding elements to the one or more users.

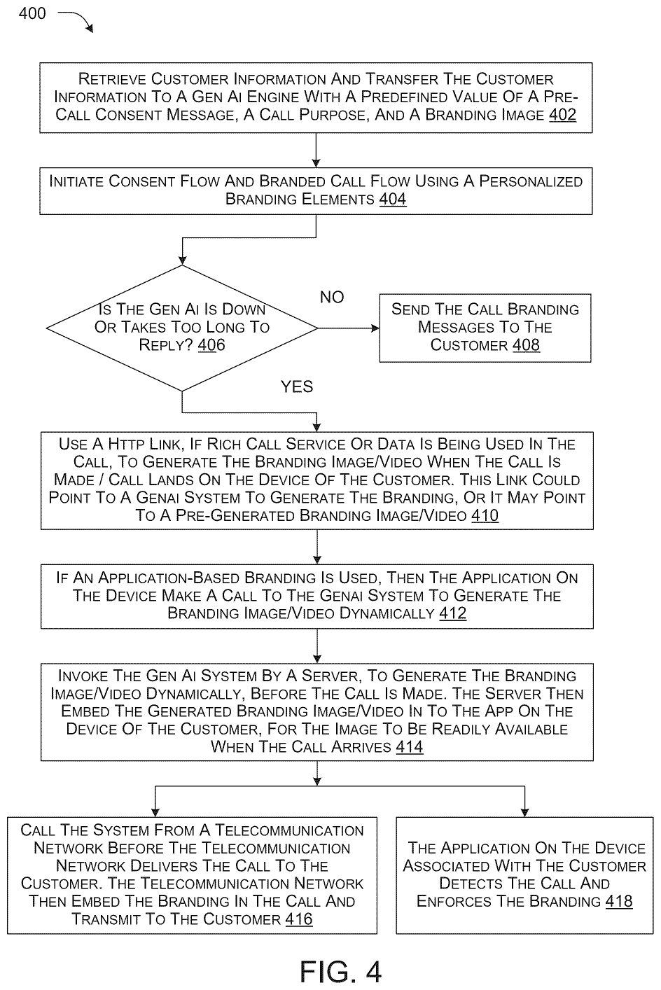

FIG. 4 illustrates an example high-level flow diagram 400 implemented by the proposed system 106, in accordance with an embodiment of the present disclosure.

As illustrated in FIG. 4, at step 402, the method may include retrieving customer information and transferring the customer information to a Gen AI engine 214 with a predefined value of a pre-call consent message, a call purpose, and a branding image. At step 404, the method may include initiating, a consent flow and a branded call flow using a plurality of personalised branding elements. At step 406, the method may include checking, if the Gen AI engine 214 is down or taking long time to reply to the customer. At step 408, if the Gen AI engine 214 is working on time, the method may include sending the call branding messages to the customer. At step 410, if the Gen AI system 214 is down or taking a long time to reply, the method may include, using a Hypertext Transfer Protocol (HTTP) link, determining if a rich call service or data is being used in the call, to generate the branding image/video when the call is made/call lands on the device 104 associated with customer. This link may point to the Gen AI engine 214 to generate the branding, or it may point to a pre-generated branding image/video. At step 412, if an application-based branding is used, the method may include making the call, to the Gen AI engine 214, using an application on the device/UE 104, to generate the branding image/video dynamically. At step 414, the method may include invoking the Gen AI engine 214, by a server, to generate the branding image/video dynamically, before the call is made. The server may embed the generated branding image/video in a message to the application on the device/user equipment of the customer, for the image to be readily available when the call arrives. At step 416, the method may include detecting, by the application on the device 104 associated with the customer, the call and enforcing the branding. At step 418, the method may include calling the system 106 from a telecommunication network 104 before the telecommunication network 104 delivers the call to the customer. The telecommunication network 104 may embed the branding in the call and transmit to the customer.

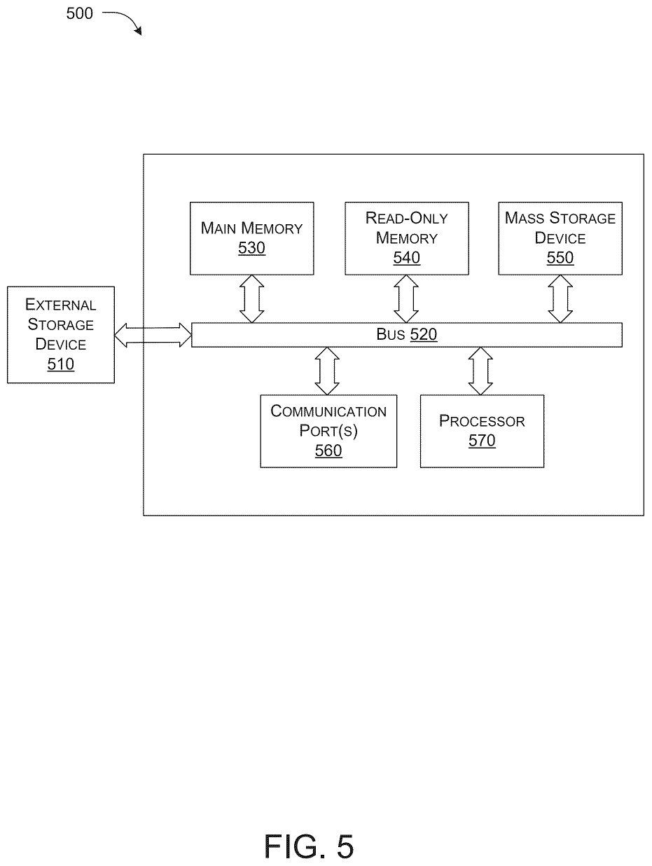

FIG. 5 illustrates an exemplary computer system 500 in which or with which the proposed system 106 may be implemented, in accordance with an embodiment of the present disclosure.

As shown in FIG. 5, the computer system 500 may include an external storage device 510, a bus 520, a main memory 530, a read-only memory 540, a mass storage device 550, a communication port(s) 560, and a processor 570. A person skilled in the art will appreciate that the computer system 500 may include more than one processor and communication ports. The communication port(s) 560 may be chosen depending on a network, such as a Local Area Network (LAN), Wide Area Network (WAN), or any network to which the computer system 500 connects. The main memory 530 may be Random Access Memory (RAM), or any other dynamic storage device commonly known in the art. The read-only memory 540 may be any static storage device(s) e.g., but not limited to, a Programmable Read Only Memory (PROM) chip for storing static information e.g., start-up or basic input/output system (BIOS) instructions for the processor 570. The mass storage device 550 may be any current or future mass storage solution, which can be used to store information and/or instructions.

The bus 520 may communicatively couple the processor 570 with the other memory, storage, and communication blocks. Optionally, operator and administrative interfaces, e.g., a display, keyboard, and cursor control device may also be coupled to the bus 520 to support direct operator interaction with the computer system 500. Other operator and administrative interfaces can be provided through network connections connected through the communication port(s) 560. In no way should the aforementioned exemplary computer system 500 limit the scope of the present disclosure.

While the foregoing describes various embodiments of the disclosure, other and further embodiments of the invention may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

### Advantages of the Present Disclosure

The present disclosure provides a system and a method for implementing personalised call branding.

The present disclosure provides campaign specific properties such as a purpose of a campaign, a region, a product, and the like to generate the personalised branding.

The present disclosure provides protection to the brand and enhances the branding using multiple consistent themes for better customer experience.

The present disclosure provides a pre-call consent message to the customer prior to the call to obtain consent of the customer.

The present disclosure leverages Generative Artificial Intelligence (AI) (Gen AI) to dynamically generate personalized consent messages, call purposes, and branding images or videos based on customer demographics, preferences, and past interactions, thereby increasing call acceptance rates.

The present disclosure allows real-time adaptation of branding content for individual customers across large-scale campaigns, ensuring that personalization is maintained without additional manual configuration effort.

The present disclosure allows the Gen AI engine to operate within predefined brand guidelines, balancing personalization with consistent brand identity.

The present disclosure enhances the impact of marketing and service campaigns, improving customer trust, relevance, and response to calls.

1. A system (106) for generating personalized call branding, comprising:
a processor (202); and
a memory (204) operatively coupled with the processor (202), wherein said memory (204) stores instructions which, when executed by the processor (202), cause the processor (202) to:
receive campaign-specific data from one or more entities, wherein the campaign-specific data comprises one or more default branding elements;
receive data associated with one or more users;
generate, via a Generative Artificial Intelligence (Gen AI) engine (214), one or more customized messages to the one or more users based on the campaign-specific data and the data;
configure a pre-call consent message prior to establishing a call with the one or more users and transmit a call purpose message and a branding content during the call, wherein the one or more customized messages comprise the call purpose message and the branding content; and
in response to a determination that a response time associated with the Gen AI engine (214) exceeds a predetermined value,
generate one or more pathways to transmit the one or more default branding elements to the one or more users.

2. The system (106) as claimed in claim 1, wherein to generate the one or more pathways, the processor (202) is configured to:
determine if a rich call service (RCS) is being used and correspondingly transmit a hyperlink comprising the one or more customized messages dynamically generated by the Gen AI engine (214) or retrieved from a pre-generated database, wherein the one or more customized messages comprise a branding image or a video;
determine if an application-based branding is used and correspondingly allowing an application on a user equipment operated by at least one user among the one or more users to make a call to the Gen AI engine (214), wherein the Gen AI engine (214) dynamically generates the branding image or the video during the call;
in response to a determination that a request has been initiated by a server, allow the server to invoke the Gen AI engine (214) prior to initiating the call and embedding the branding image or the video in a message sent to the user equipment; and
use a telecommunications network to deliver the branding image or the video via call signaling prior to delivering the call to the user equipment (104).

3. The system (106) as claimed in claim 2, wherein the Gen AI engine (214) is pre-configured with one or more brand constraints comprising any or a combination of: a limiting media size or resolution associated with the branding image, a restricted inclusion of the one or more users, a restricted inclusion of one or more objects, or a restricted usage of one or more categories of content received from the one or more entities, a restricted usage of one or more authorized logos, a restricted usage of one or more themes, or one or more colours.

4. The system (106) as claimed in claim 1, wherein the data comprises at least one of: an age attribute associated with the one or more users, a gender attribute associated with the one or more users, an education attribute associated with the one or more users, a location attribute associated with the one or more users, an economic status attribute associated with the one or more users, and one or more prior brand interaction attributes associated with the one or more users.

5. The system (106) as claimed in claim 3, wherein the pre-call consent message comprises a string of text sent to the one or more users prior to the call, wherein the call purpose message comprises the string of text displayed during the call, and the branding image or the video comprises an image or a video sequence displayed on the user equipment (104) during the call.

6. A method (300) for generating personalized call branding, the method (300) comprising:
receiving (302), by a processor (202), associated with a system (106), campaign-specific data from one or more entities, wherein the campaign-specific data comprises one or more default branding elements;
receiving (304), by the processor (202), data associated with one or more users;
generating (304), by the processor (202), via a Generative Artificial Intelligence (Gen AI) engine, one or more customized messages to the one or more users based on the campaign-specific data and the data;
configuring (304), by the processor (202), a pre-call consent message prior to establishing a call with the one or more users and transmitting a call purpose message and a branding content during the call, wherein the one or more customized messages comprise the call purpose message and the branding content; and
in response to a determination that a response time associated with the gen AI engine exceeds a predetermined value,
generating (306), by the processor (202), one or more pathways to transmit the one or more default branding elements to the one or more users.

7. The method (300) as claimed in claim 6, wherein for generating the one or more pathways, the method (3000 comprises:
determining, by the processor (202), if a rich call service (RCS) is being used and correspondingly transmitting a hyperlink comprising the one or more customized messages dynamically generated by the GenAI engine or retrieved from a pre-generated database, wherein the one or more customized messages comprise a branding image or a video;
determining, by the processor (202), if an application-based branding is used and correspondingly allowing an application on a user equipment (104) operated by at least one user among the one or more users to make a call to the Gen AI engine (214), wherein the Gen AI engine (214) dynamically generates the branding image or the video during the call;
in response to a determination that a request has been initiated by a server, allowing, by the processor (202), the server to invoke the Gen AI engine (214) prior to initiating the call and embedding the branding image or the video in a message sent to the user equipment (104); and
using, by the processor (202), a telecommunications network for transmitting the branding image or the video via call signaling prior to delivering the call to the user equipment (104).

8. The method (300) as claimed in claim 7, comprising:
pre-configuring, by the processor (202), the Gen AI engine (214) with one or more brand constraints comprising any or a combination of: a limiting media size or resolution associated with the branding image, a restricted inclusion of the one or more users, a restricted inclusion of one or more objects, or a restricted usage of one or more categories of content received from the one or more entities, a restricted usage of one or more authorized logos, a restricted usage of one or more themes, or one or more colours.

9. The method (300) as claimed in claim 8, comprising:
receiving, by the processor (202), data associated with the one or more users prior to initiating the call; and
transmitting, by the processor (202), the data to the Gen AI engine (214) for generating one or more customized messages comprising the one or more brand constraints.
